(19) United States
(12) Patent Application Publication
(10) Pub. No.: US 2008/0311300 A1
(43) Pub. Date: Dec. 18, 2008

(54) Composition and Use Thereof

(75) Inventors: Dirk Burdinski, Eindhoven (NL); Milan Saalmink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/996,606

(22) PCT Filed: Jul. 21, 2006
(86) PCT No.: PCT/IB2006/052499

§ 371 Date: Jan. 24, 2008

(30) Foreign Application Priority Data
Jul. 28, 2005 (EP) 05106968.0

(51) Int. Cl. B05D 1/36

(52) U.S. Cl. 427/265

(57) ABSTRACT

The composition is suitable for the provision of monolayers on selected surfaces. Thereto, it comprises a first compound able to form a monolayer on a first surface, and a second compound able to form a monolayer on a second surface that is different from the first surface, which first and second compounds are chosen such as to be mutually at least substantially inert. The selected surfaces may be present on a single substrate, which allows homogenization, and the provision of masking surfaces covering part of the underlying surfaces. The selected surfaces may alternatively present on different substrates, allowing the use of a printer with a standardized printing pattern.

The invention relates to a composition for the provision of a monolayer on a surface.

The invention also relates to use of said composition for the provision of a monolayer, and to a method of manufacturing an article comprising the provision of said monolayer.

Monolayers have been studied intensively in the previous years, particularly in the context of micro contactprinting. With this printing technique, the monolayers could be applied as a very thin photoresist and also as surface modifiers to create selective adsorption of further compounds. An overview of micro contactprinting is given in the article of Whitesides and Xia, Angewandte Chem. Int. Ed., 37 (1998), 550-575.

Recently, questions have been addressed in relation to micro contactprinting that primarily relate to industrialization of the technique. A stamp with a stamping surface of a few cm² is insufficient for the patterning of an electronic substrate such as a silicon wafer, and alignment issues come up. So far, the best approach to solve this industrialization issue has been the introduction of wave printing, wherein individual portions of a large stamping surface are put forward to the substrate after each other. This is carried out in such a manner, that the stamping surface walks as a wave over the substrate.

However, not all industrialization issues are solved with the introduction of micro contactprinting. There are some issues in particular with the stamps. First of all, there is a problem with reliability. The patterned stamping surface is generally obtained in that there are recessed portions. However, these portions may come into contact with the substrate to be patterned, if the recess is wide and insufficiently deep and/or by deformation of the stamp due to the pressure provided during stamping. Another issue with the stamps is the time needed for their preparation. These stamps are generally prepared from polydimethylsiloxane (PDMS) in a replica process from a master. A more suitable process so as to obtain sufficiently deep recesses is even a double replica process, starting from a silicon substrate. However, it is a time consuming process, in addition to the costs of making a master. And since one needs a separate stamp for each layer and each pattern to be printed, the manufacture of stamps tends to get a burden for the industrialization of micro contactprinting.

It is therefore an object of the invention to reduce the problem in relation to the stamp manufacture.

This object is achieved in the invention in a composition for the provision of a monolayer on a selected surface, in that the composition a first compound able to form a monolayer on a first surface, and a second compound able to form a monolayer on a second surface that is different from the first surface, which first and second compounds are chosen such as to be mutually at least substantially inert.

According to the invention, it is not the stamp that is modified but the composition with which the monolayer is applied to the surface of the substrate to be printed. Monolayer forming compounds are usually fictionalized with a suitable reactive group that allows them to interact with a substrate surface. Such monolayer forming compounds adsorb only on specific surfaces, so that for patterning one type of surface one needs a specific compound. By selecting a first and a second compound such that they are mutually at least substantially inert, it was achieved that one stamp may be used for providing a pattern on more than one surface.

It is observed that U.S. Pat. No. 5,512,131 discloses a composition including a first and a second compound for forming a monolayer on a selected surface, see particularly column 12, lines 55-59. However, the compounds are very similar; indeed the only difference between them is the length of the apolar chain and not the functional group. As a consequence, this known composition is suitable only for providing a monolayer on a single surface, and the first and the second compound will be transferred simultaneously. The composition of the present invention may be used for providing monolayers on different surfaces, in that on each surface selective transfer of either the first or the second compound takes place. As a consequence, generally, the first and the second compound will have different chemical properties and may have different physical properties. Particularly, the functional group of the first and the second compound are generally different.

It is an advantage of the invention that the resulting patterns printed with the composition of the invention tends to be better than previously obtained. Particularly, less defects were found. So far, the inventors have the impression that this improved printing is due to an increased stability of the printed compound and/or that the second compound acts in some cases as a ‘defect healing’ additive for the creation of a monolayer of the first compound. The increased stability appears particularly given for alkanethiols in combination with acids, as the alkanethiols are in an acidic solution (e.g. solutions with a lower pH) less prone to oxidation by air oxygen. Less decomposition of the alkanethiol compound turns out to lead to an improved quality of the printed monolayer, particularly for a monolayer on a gold surface. The ‘defect healing’ effect is the effect that a compound seals a defect in an existing monolayer by a suitable orientation. As a consequence, the resulting surface can be penetrated by an etching solution only with greater effort and hence the risk of the creation of undesired etch holes is reduced. This has been proven to be the case for alcohols, such as octanol, in alkaline and neutral solution (M. Geissler et al. Langmuir, 18, 2374-2377 (2002)) and for sulfonic acids, such as decanesulfonic acid, in acidic solutions.

In a preferred embodiment, the first compound is derived from an organic or hetero-organic acid and the second compound is an organic compound that is not substantially decomposed by the first compound. This implies that the second compound should not function as a base for the first compound, or at least that the second compound is a weaker base than the solvent. If such an internal reaction would take place, the reactivity of the first compound would be considerably reduced and the first compound may not adsorb properly on the selected surface. Or it may be that the protonated second compound would hinder the adsorption reaction due to Coulomb repulsion with the surface or with other molecules.

A hetero-organic acid is understood, in the context of this application, to be an organic acid which includes hetero-atoms in its claim. The term ‘derived from’ is understood to mean that the compound as a whole may have further functionality than the acid and/or that the acid may be modified with a protective group on the acid group. This protective group then is removed in the adsorption reaction with the selected surface.

Acids are particularly suitable for the provision of monolayers on metal oxide and glass surfaces. However, they may also be used for the provision of monolayers on polymer surfaces which have the required surface structure. Suitable first compounds are particularly alkanephosphonic acids, alkanephosphinic acids, alkanesulfonic acids, alkanesulfinic acids, carboxylic acids, hydroxamic acids, hydroxysilanes and derivatives thereof.

The second compound is for instance a sulphur-containing compound and would be very suitable for adsorption to a selective metal surface. Proper examples of sulphur-containing compounds suitable for forming a monolayer are alkanethiols, dialkyldisulfides, dialkylsulfides, 2,2-disubstituted propane-1,3-dithiols, thiocarboxylic acids, and dithiocarboxilic acids. Most suitable second compounds are thiols, as for the reason given above that the thiols in acids turn out to give a monolayer with less defects. If the second compound is a sulfur-containing compound other than a thiol (e.g. disulfide, thioether, or thiocarboxylic acid), it may be cleaved by the solvent, which can be catalyzed by an acid, in this case thus the first compound.

The combination of an acid and a sulphur-containing compound leads to a composition that can be used both on a metal and on metal oxide surfaces in particular, but also for the deposition of materials on two polymer surfaces that may have been modified selectively. One example hereof is the printing on a substrate surface of SiO₂, on top of which Au or Cu patterns are provided as conductive traces. Printed patterns may thus extend on the Au and the adjacent surface, which not only allows a larger freedom in pattern creation, but also enables slight extensions on the other surface for reliability reasons. Additionally, it allows the creation of negative patterns, wherein the complete surface is covered with a monolayer, except at a number of areas. Applications hereof are for instance in the manufacture of interconnect patterns, but also in the creation of selective adsorption sites and in the provision of a localized surface modification or adhesion promotor.

In another embodiment, the first compound comprises an activated hydroxysilyl-functional group and the second compound comprises a sulfur-functionalized group. The silyl-functional groups allows the creation of a monolayer onto a metal surface forming an oxide, such as silicon and aluminum, allowing patterning of these metals. Particularly, the first compound comprises a hydroxysilylalkane derivative and an aprotic solvent is present. The second compound is in particular a reactive cyclic thioether. This combination is a suitably inert combination of compounds. In principle, a reactive cyclic thioether undergoes proton-induced decomposition. Here, the required mutual inertness is achieved by the choice of a not proton-acidic derivative of a hydroxysilylalkane, octadecyltrichlorsilane, is chosen as the first compound. Moreover, the composition does not contain any water. If water were present, the chlorosilane would be hydrolyzed to form two acids (hydrochloric acid, and trihydroxyalkylsilane), which in turn can cause the decomposition of the cyclic thioether.

As will be understood by the person skilled in the art, not all alkanes are capable of forming monolayers. Generally, the alkanes are C₆-C₂₀ alkanes, but the main chain can contain various other structural or functional groups, such as amide, amino, ester, ether, keto, silyl groups etc. These groups may constitute a major part of the chain, such as in oligo(ethyleneglycol) groups (OCH₂CH₂)ₙ. Moreover, the alkanes are preferably linear, but methyl or ethyl side groups could be present. The alkanes could be branched or substituted in any other way. However, in most cases a less good packing of the monolayer is obtained with non-linear alkyl chains. Exceptions are chains that are modified with hydrogen-bonding functional groups. These hydrogen-bonding functional groups are capable of significantly increasing the interaction between the individual monolayer forming molecules. Therewith, they may cause a stabilization of the monolayer.

Furthermore, the compounds may contain another end group in addition to the functional group suitable for selective adsorption. This end group is suitable in order to provide the adsorbed monolayer with a specific surface property. It will be clear that such end group must not be reactive with either of the functional groups present in the composition.

The invention also relates to use of the composition of the invention to form monolayers on selected surfaces. Here, several embodiments are envisaged:

In a first embodiment, the pattern is transferred subsequently to different surfaces. Here two monolayers are created in different stages of the processing. Alternatively, the same pattern may be created on different substrates, such as for instance a polymer substrate and an oxide substrate.

In a second embodiment, the pattern is transferred simultaneously to different surfaces on one substrate. The different surfaces comprise different materials or the same material in a different physical state or in a different activity state with respect to their chemical reactivity. The resulting reactivity differences towards different components of the composition result in the selective formation of different monolayers on any of these surfaces comprising different monolayer-forming molecules of the composition. The forming of such a monolayer of such functionalized compounds on a specific surface is a process that evolves by self-assembly. The monolayers are therefore commonly referred to as self-assembled monolayers or in abbreviation SAM. If the different SAM-forming molecules bear different reactive head groups for bond formation with the substrate surface, but similar or even identical tail groups, which are eventually exposed at the substrate-air interface, this effectively leads to homogenization of the substrate. Additionally, one may use the composition not just in a printing process, but also with spin coating and the like processes for provision of a non-patterned surface.

One example hereof is the homogenization of substrate surfaces for instance in the packaging of electronic devices. Here, a good adhesion of an overmoulded compound to all surface parts of the substrate and optionally any component on the substrate are required. However, the substrate may be of polymer with conductive tracks, and the component may have a top layer of silicon nitride or any kind of polymer, such as benzocyclobutane. In this specific application, a printing process and particularly a contactprinting process are preferred above others such as spin coating or gasphase modification or dipping. The reason thereof is that neither the solution is spread around nor that a cleanroom is needed for the process.

Another example hereof is the homogenization of surfaces in biochemistry, biosensors, or medical devices. A microfluidic system comprising walls made of different materials (e.g. a glass bottom, a polymer top and walls made of metal or different metals), can be modified in order to expose a homogeneous surface to the fluid. This is achievable by using the composition of the invention for passing it through such a microfluidic system to modify all surfaces in one stroke.

In a further example of this second embodiment, the self-assembled monolayer is partially present on one, for instance metal, surface and partially on a neighboring, for instance isolating surface. In this example, a multilayer structure is created. One application hereof is for instance the use of the monolayer as a solder-mask. This solder-mask often partially overlaps the underlying metal bond pad and partially is present on the insulating material around the bond pad.

In a third embodiment, the composition may be used for different surfaces on different substrates. Effectively, this may be used with a stamp that has a standardized pattern. This could for instance be a resist for a vertical interconnect area. In combination with an apparatus, wherein the stamp may be transferred laterally and be aligned with structures on the substrate, then the stamp may be used for selectively printing. The pattern could be a dot, but alternatively a ring-shaped structure around a dot, an electrode pattern of a transistor or another element. In other words, this allows contactprinting in a manner similar to inkjetprinting, but with a higher resolution and with the ability to print more patterns than only a dot.

In an example hereof, this is applied so as to selectively modify the surface. A further layer applied in another process, such as spin coating, dipping, vapor deposition, sputtering or inkjetprinting, will then selectively adsorb to the printed area or selectively keep the printed area free.

In another example, this printing principle is applied to modify the surface area for a subsequent process step. A ring-shaped pattern may be used as a solder-resist mask in a packaging process, therewith selectively covering exposed interconnects, or somewhat reducing the size of the contact pad. A ring-shaped pattern may also be used so as to reduce the contact area of an underlying surface. For instance in biosensors, it is desired to provide droplets of liquid such as blood or body liquid on a reactive surface. The dot-pattern effectively sets and may limit the size of the reactive surface while ensuring that the liquid does not spread over the complete surface. Also, the dot-pattern is very effective to define such dot-patterns of different diameter on different areas of the substrate.

The use of the composition of the invention is suitably one step in a method of manufacturing an article, particularly a microelectronic device such as a biosensor, a semiconductor device or a display. However it may be further applied to other articles, or to articles including such a microelectronic device.

One such example is for instance the provision of identification patterns on security documents such as banknotes, passports, driving licenses, cheques and tickets. In one example, such patterns comprise fluorescent and non-fluorescent molecules. This fluorescence can be printed in a high resolution, allowing the creation of patterns for optical read out with a high information density. With the printing method, the pattern may be printed as part of the ordinary printing process or even thereafter. Although this is better enabled with the use of the composition of the invention, it is not excluded that this may also be achieved with ordinary compositions suitable for contactprinting.

In case of using the composition in micro contactprinting, it is suitably used in combination with a stamp having a substantially planar stamping surface. Such a stamp may be made in that parts of the stamping surface are chemically modified. This is further explained in the non-prepublished patent application PCT/IB2005/052111 (internal number PHNL050195).

In case of contactprinting and similar soft-lithographical techniques, it is moreover highly suitable to use the stamp as a part of a larger printing equipment. The stamp is suitably a replacible part, so as to allow the transfer of different patterns on different surfaces with one type of equipment. One such type of equipment is the waveprinter. This equipment fulfils the functions of alignment with the substrate and provision of pressure so as to bring the stamping surface in contact with the substrate. Pressure is preferably provided locally only.

These and other aspects of the invention will be further explained with reference to the Figures and examples, in which:

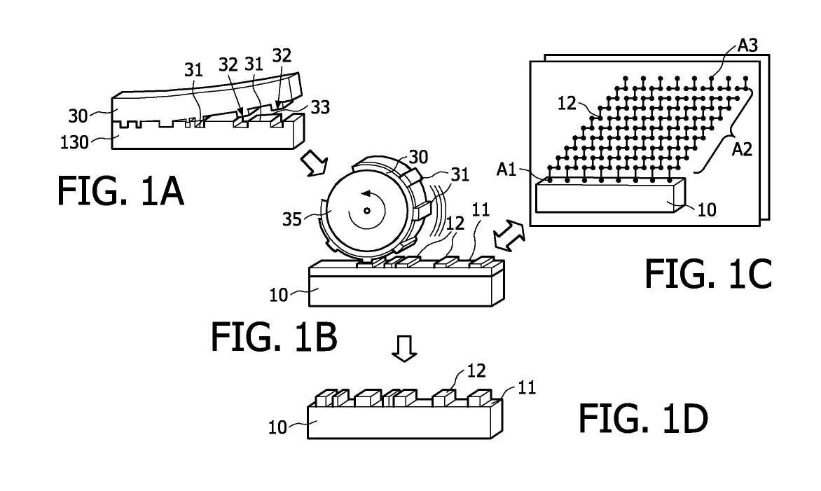

FIGS. 1A-D show diagrammatical, cross-sectional views of a stamp for use in contactprinting on a substrate surface, as well as the resulting monolayer.

FIG. 1 shows in four diagrammatical, cross-sectional views an overview of micro contactprinting.

FIG. 1A shows a stamp 30 that is peeled off from a master 130. The stamp has a stamp surface 31 with protrusions 32 adjacent to voids 33. The stamp is usually made from poly(dimethylsiloxane) (PDMS). The combination of protrusions forms a desired pattern that is to be provided on a surface 11 of a substrate 10. Instead of a stamp surface 31 with protrusions 32, one may alternatively use a stamp with a substantially planar surface 31, which is patterned chemically. A very suitable manner to make such a stamp resides in the provision barrier film on the stamp surface according to the desired pattern. This barrier film is subsequently protected with a passivation layer that has the same pattern as the barrier film. The barrier film could be a metal or an oxide, but also a modified region of the stamp 30. The passivation layer could be a monolayer, but any other material is suitable as well. If the barrier layer is a modified region of the stamp, its binding to the passivation layer ensures that the constituents of the barrier layer will not diffuse into the stamp. This stamp has been described in the non-prepublished patent application (PHNL050195).

FIG. 1B shows the stamp 30 during the printing process on the surface 11 of a substrate 10. In this case, the surface 11 is given as a separate layer. The stamp 30 is attached to a carrier 35, which is in this case a roll. However, optimal results have been achieved with the use of a wave printing equipment as known from WO-A 2003/99463. With the help of this equipment, portions of the stamp 30 are subsequently brought in contact with the substrate surface 11, in a movement analogous to the propagation of a wave. The wave printing provides a homogeneous pressure and contact-time over the complete surface 11. Before the stamp 30 is brought in contact with the surface 11, it is impregnated with the composition of the invention, also referred to as ink. The ink diffuses into the stamp 30. During the printing process, ink diffuses towards the stamp surface 31 and comes into contact with the substrate surface 11. Adhesion to the substrate surface 11 of compounds in the ink may occur, if this is energetically favorable. This depends on the surface 11 and on the compounds.

FIG. 1B additionally shows the pattern 12 that is provided on the substrate surface 11 with the stamp 30. This pattern comprises in fact a monolayer only, to which will be also referred hereinafter as a self-assembled monolayer or SAM. The structure of this pattern 12 is further elucidated in FIG. 1C, which shows that the pattern is a monolayer of molecules A that is adsorbed to the substrate surface 11. The molecule A is a typical monolayer forming compound, with a functional end group A1, and an apolar chain A2 of sufficient length, usually an alkylchain. The end group A3 may be functionalized, but need not to be.

The adsorption of the compound A to the substrate surface 11 is the result of the formation of a specific and strong chemical bond between the molecules forming the monolayer and the material, of which the substrate surface is composed. The necessity for different ink molecules is caused by the rather different chemical properties of the various materials (M): coinage metals form very strong bonds with sulfur-containing molecules, preferably alkanethiols:

R—S—H+M-->R—S-M+½H₂ (1)

Metal oxides, which usually show various degrees of hydratization at their surface, form very strong bonds with molecules containing acidic hydroxy-groups, such as alkanephosphonic acid, alkanephosphinic acids, alkanesulfonic acids, alkanesulfinic acids, carboxylic acids, hydroxamic acids, or hydroxysilanes:

RX—OH+HO-M-->RX—O-M+H₂O (2)

Instead of hydroxyl-functionalized ink molecules, activated precursors, such as chlorides (e.g. silylchlorides, see above) or alkoxy-compounds, may be used, which principally provide the same type of product:

RX—Cl+HO-M-->RX—O-M+HCl (3)

R¹X—O—R²+HO-M-->R¹X—O-M+HO—R² (4)

The individual chemical properties of the metal oxides determine the best choice of ink. Silicon and silicon oxide have been proven to be best patterned with silylchloride, while aluminum and aluminum oxide are better patterned with phosphonic acid inks.

Since there is apparently not a single class of molecules suitable to pattern all these classes of materials, we propose the use of mixed compositions of different ink molecules as universal ink solutions. We have found that with the right choice of components, ink compositions can be obtained, which are indeed suitable to print on a variety of different materials, including coinage metals as well as metal oxides, with no loss in quality. Furthermore we developed compositions, which do not suffer from chemical cross-reactivity of the individual molecules of the composition.

FIG. 1D finally shows a potential further step after the provision of the pattern 12 on the substrate surface 11. This step is the etching of the layer at the substrate surface 11 using the pattern 12 as an etch mask. However, this is only one of many possibilities. Indeed, it appears that the composition of the invention not only is functional to be used as an etch mask, but also as a mask for the deposition of a further layer. Effectively, the potential to provide a monolayer on two different surfaces allows the provision of an additional pattern on a surface that includes a pattern already.

In a first embodiment of the ink of the invention, an ink was prepared for patterning coinage metals (Au, Ag, Cu, Pd), oxide forming metals (e.g. Al), and metal oxides (ITO, IZO, Al₂O₃, . . . ). Patterning of coinage metals (Au, Ag, Cu, Pd), oxide forming metals (e.g. Al), and metal oxides (e.g. ITO) has been achieved with mixed ethanolic solutions containing an alkanethiol (RSH), in particular n-octadecanethiol with the molecular formula CH₃(CH₂)₁₇SH; this compound will be abbreviated as ODT. The ethanolic solutions further contained an alkanephosphonic acid. Such acids have as a general formula RPO₃H₂, with R an group suitable for the formation of a monolayer, as identified above. The particular example chosen was octadecanephosphonic acid (CH₃(CH₂)₁₇PO₃H₂), further abbreviated as ODPA.

In general, the maximum concentration of the active components is determined by its solubility in the particular solvent (usually, but not exclusively ethanol) and its tendency to spread on the substrate surface during printing. An increasing spreading tendency is usually observed at higher concentrations. The lower concentration limit results from the quality of the obtained SAM, which usually decreases with a decrease in ink concentration.

For ODT an upper concentration limit of about 8 mM results from the relatively low solubility in ethanol. In the case of ODPA the solubility in ethanol is significantly higher and consequently an ink concentration of about 10 mM is often used in micro contactprinting, in order to obtain SAMs of high density. In our experiments we have used mixtures of ODT (2 mM) and ODPA (10 mM) with these preferred concentrations. However, depending on the particular application and solvent system, the concentration of any of the components may be varied significantly (0.05 . . . 50 mM). As indicated, alternative solvents may be used. The preferred solvent, in turn, also depends on the employed stamp material. The combination of alkanethiols with alkanephosphonic acids may thus be used in different ink solutions under various conditions.

An important aspect of the invention is the stability of the ink solution. Whenever two chemicals are mixed in a solution, they may potentially react with each other, which can result in decomposition of the ink solution. Alkanephosphonic acids are relatively strong acids and are in general neither oxidation sensitive nor oxidizing agents. Alkanethiols are moderately strong acids and oxidation sensitive, e.g. against air oxygen. The oxidation sensitivity increases with an increasing pH or, in other words, alkanethiols are generally more stable in an acidic solution. Therefore no cross reaction between the two components can be expected. Indeed, we did not observe any degradation of such mixed ink solutions. On the contrary, we believe that the stability of the thiol component has increased due to the presence of the acidic second component.

The same argument holds for alternative ink compositions composed of a sulfur-containing component (generally oxidation sensitive) as the most active inks for coinage metal patterning in combination with an acidic hydroxyl-containing ink component suitable for the patterning of metal oxide surfaces. Examples for the sulfur-containing component are dialkyldisulfides (RSSR), dialkylsulfides (R₂S), and multifunctional alkanethiols (X—(R—SH)ₙ, n=1-6). Recently proposed ink molecules for printing on coinage metal surfaces are furthermore 2-mono- and 2,2-disubstituted propane-1,3-dithiols (R¹R²C((CH₂)SH)₂), thiocarboxylic acids (RCOSH), and dithiocarboxylic acids (RCS₂H).

Herein, as in the following, R generally refers to an alkyl- or a similar group, such that the molecule is capable of forming a monolayer. Such compounds have generally a alkyl-chain. Generally, the alkylchains are C6-C20 alkyl, but the main chain can contain various other structural or functional groups, such as amide, amino, ester, ether, keto, silyl groups etc. These groups may constitute a major part of the chain, such as in oligo(ethyleneglycol) groups (OCH₂CH₂)ₙ. Moreover, the alkylchains are preferably linear, but methyl or ethyl side groups could be present. The alkylchains could be branched or substituted in any other way. The alkylchains moreover may be provided with functional end groups and the usual substitutions, such as halogens, hydroxy, nitro, amino, toluoyl and the like.

The second component, which has a high affinity for the surface-oxide forming material, may, among others, be of the following group of compounds: alkanephosphinic acids (RPO₂H₂), alkanesulfonic acids (RSO₃H), alkanesulfinic acids (RSO₂H), carboxylic acids (RCO₂H), hydroxamic acids (RC(O)NOH), or hydroxysilanes (RSi(OH)₃) or derivatives thereof. In general, the members of these two groups are chemically sufficiently inert against each other to allow usage within the same ink solution.

The mixed ink solution may contain more than two components.

The inking of the stamp may be achieved in various ways. The stamp may, for instance, be immersed in a solution of the ink molecules in a suitable solvent or it may be exposed to a sample of the pure compound, preferably if it is in the liquid state. The solution may alternatively be applied to the stamp by means of an inking tool, such as a piece of fabric, which has been soaked with the respective inking solution. The stamp may also be exposed to those molecules via the gas phase.

In a second embodiment of the invention, an ink was prepared for use for coinage metals (Au, Ag, Cu, Pd), oxide forming metals (e.g. Al), and metal oxides (ITO, IZO, Al₂O₃, . . . ), including silicon. Many of the aspects discussed for the above ink compositions also apply here. The most suitable class of ink molecules for the patterning of silicon or silicon oxide includes hydroxysilylalkane derivatives, such as silylalkoxides ((R¹ₙSi(OR²)ₘ, n=1-3, m=4−n, R²=Methyl, Ethyl, . . . ) and, most preferably, silylchlorides (RₙSiClₘ, n=1-3, m=4−n). These molecules bear activated hydroxysilyl-functional groups, which are particularly suitable to form strong bonds to silicon oxide surface. The latter usually exhibit a relatively low reactivity towards non-activated hydroxyl-functionalized agents. The described advantage of this particular group of ink molecules at the same time makes them somewhat more problematic to use in the proposed general ink solutions. Since they react readily with surface hydroxyl groups, they do as easily react with the free hydroxyl or thiol groups of other ink components. Therefore, they cannot be used in combination with any ink molecules bearing free hydroxy or thiol functional groups. A general ink solution for coinage metals as well as metal oxide surface, including silicon and silicon oxide thus is composed of a hydroxysilylalkane derivative and a sulfur-functionalized component, such as a thioether derivative, which does not react with the other component.

As an example, we have used 2-heptadecyl-1,3-dithiacyclopentane (1) as the thioether component in combination with octadecyltrichlorosilane as the hydroxysilylalkane derivative component in a cyclohexane ink solution, as described in Example 2.

### EXAMPLE 1

Four different substrate surfaces were prepared: of gold, of aluminum, of indium-tin-oxide (ITO) and of silicon

The gold surface was prepared on a silicon wafer. The silicon wafer was provided with a thermal oxide in a thickness of about 500 μm. A titanium adhesion layer (2 nm, sputtered) and a gold top layer (20 nm, sputtered) were deposited herein. In order to clean the thus prepared gold surface, it was rinsed with water, ethanol, and heptane, and subsequently dried in a stream of nitrogen and further exposed to an argon plasma (0.25 mbar Ar, 300 W, 5 min).

The aluminum surface was prepared on a glass plate. The aluminum top layer of 50 nm was applied by vapor deposition on a methyl methacrylate adhesion layer on the glass plate. It was used in the experiment directly after its preparation.

The ITO surface was prepared on a glass plate. The ITO layer had a thickness of 135 nm and was cleaned in a standard cleaning procedure. It was subsequently exposed to an oxygen plasma (0.20 mbar Ar, 200 W, 30 s).

The silicon surface was prepared by rinsing a silicon wafer with acetone (to remove an organic protective film) and water. Thereafter, the wafer was immersed in a Piranha solution (conc. H₂SO₄ and H₂O₂ (30%), 7:3) and rinsed with water, ethanol, and heptane. Finally, it was dried in a stream of nitrogen.

### EXAMPLE 2

Three ink solutions in ethanol were prepared:

Ink solution A contained only octadecanethiol (2 mM)

Ink solution B contained only octadecylphosphonic acid (10 mM)

Ink solution AB contained- octadecanethiol (2 mM) and octadecylphosphonic acid (10 mM).

### EXAMPLE 3

Identical 1×2 cm² PDMS stamps was immersed in each of the solutions of Example 2 and equilibrated for about 1 hour, removed from the solution, rinsed with ethanol, and dried in a stream of nitrogen. In each experiment one of these stamps was brought into contact with one of the substrates with a Au surface, an Al surface and an ITO surface as prepared in Example 1. The contact time depended on the surface material: Au, 15 s; Al, 3 min; ITO, 3 min. All nine possible substrate/ink combinations were investigated. The substrates were subsequently subjected to wet chemical etching using the following etching solutions at room temperature:

1. Gold: Etching bath composed of potassium hydroxide (1.0 M), potassium thiosulfate (0.1 M), potassium ferricyanide (0.01 M), potassium ferrocyanide (0.001 M) and octanol at half saturation in water. Etching time: 8-10 minutes.
2. Aluminum: Etching bath composed of 0.1% hydrogen peroxide (H₂O₂) at pH 12 (potassium hydroxide, KOH) in water. Etching time: about 1-2 minutes.
3. Indium-Tin-Oxide (ITO): Etching bath composed of hydrochloric acid (HCl (18%)) and ferric chloride (2.7%) in an aqueous solution. Etching time: 10-15 minutes.

### Results

Clearly defined patterns were obtained after the etching procedure for the substrate/ink combinations gold/ink A, aluminum/ink B, and ITO/ink B, and no or poorly defined patterns were obtained for the substrate/ink combinations gold/ink B, aluminum/ink A, and ITO/ink A, as expected. For all substrates a clearly defined pattern was obtained with a stamp being inked the same new ink composition AB, however. Feature resolutions of down to 1 μm were observed. The quality of the patterns obtained with the mixed ink compositions was in all cases either comparable or better than those obtained with ink solutions containing only a single type of ink molecules.

### EXAMPLE 4

Three ink solutions in cyclohexane (low water content) were prepared:

Ink solution C contained only heptadecyl-1,3-dithiacyclopentane (1, 10 mM)

Ink solution D contained only octadecyltrichlorosilane (2 mM)
Ink solution CD contained-heptadecyl-1,3-dithiacyclopentane (1, 10 mM) and octadecyltrichlorosilane (2 mM).

### EXAMPLE 5

The solutions prepared in Example 4 were tested for the substrates with the gold surface, the aluminum surface and the silicon surface as prepared in Example 1. Identical 1×2 cm² PDMS stamps was immersed in each of these solutions and equilibrated for about 30 minutes, removed from the solution, rinsed with cyclohexane, and dried in a stream of nitrogen. One of these stamps was brought into contact with one of the above substrates for a defined time (Au, 1 min; Al, 5 min; Si, 5 min), and removed again. All nine possible substrate/ink combinations were investigated. The substrates were subsequently subjected to wet chemical etching using the following etching solutions at room temperature:

1. Gold: Etching bath composed of potassium hydroxide (1.0 M), potassium thiosulfate (0.1 M), potassium ferricyanide (0.01 M), potassium ferrocyanide (0.001 M) and octanol at half saturation in water. Etching time: 8-10 minutes.
2. Aluminum: Etching bath composed of 0.1% hydrogen peroxide (H₂O₂) at pH 12 (potassium hydroxide, KOH) in water. Etching time: about 1-2 minutes.
3. Silicon: a) Aqueous hydrogen fluoride solution (1 ml HF (50%), 30 ml water); etch for 3 seconds, b) potassium hydroxide solution (0.1 M); etch for about 30 minutes.

### Results

Clearly defined patterns were obtained after the etching procedure for the substrate/ink combinations gold/ink C, aluminum/ink D, and silicon/ink D, and no or poorly defined patterns were obtained for the substrate/ink combinations gold/ink D, aluminum/ink C, and silicon/ink C, as expected. For all substrates a clearly defined pattern was obtained with a stamp being inked the same new ink composition CD, however. Feature resolutions of down to 1 μm were observed. The quality of the patterns obtained with the mixed ink compositions was in all cases either comparable or better than those obtained with ink solutions containing only a single type of ink molecules.

Summarizing, the invention provides a composition that is suitable for the provision of monolayers on selected surfaces. Thereto, it comprises a first compound able to form a monolayer on a first surface, and a second compound able to form a monolayer on a second surface that is different from the first surface, which first and second compounds are chosen such as to be mutually at least substantially inert. The selected surfaces may be present on a single substrate, which allows homogenization, and the provision of masking surfaces covering part of the underlying surfaces. The selected surfaces may alternatively present on different substrates, allowing the use of a printer with a standardized printing pattern.

1-17. (canceled)

18. A composition for the provision of monolayers on selected surfaces, comprising
a first compound arranged to form a monolayer on a first surface, and
a second compound arranged to form a monolayer on a second surface that is different from the first surface,
which first and second compounds are mutually at least substantially inert and have different chemical or physical properties such that on the first surface selective transfer of the first compound takes place and on the second surface selective transfer of the second compound takes place.

19. A composition as claimed in claim 18, wherein the different chemical properties are provided by the first compound having a first functional group for interacting with the first surface and the second compound having a second functional group for interacting with the second surface.

20. A composition as claimed in claim 18, wherein first compound is derived from an organic or hetero-organic acid and the second compound is an organic compound that is not substantially decomposed by the first compound.

21. A composition as claimed in claim 20, wherein the first surface is a metal oxide, a glass or a polymer, and the second surface is a metal.

22. A composition as claimed in claim 21, wherein the first compound is or provides a source of a stronger acid than water.

23. A composition as claimed in claim 22, wherein the first compound is an acid chosen from the group of alkanephosphonic acids, alkanephosphinic acids, alkanesulfonic acids, alkanesulfinic acids, carboxylic acids, hydroxamic acids, boronic acids, hydroxysilanes and derivatives thereof.

24. A composition as claimed in claim 22, wherein the second compound is a sulfur-containing compound.

25. A composition as claimed in claim 24, wherein the sulfur-containing compound is chosen from the group of alkanethiols, dialkyldisulfides, dialkylsulfides, propane-1,3-dithiols, thiocarboxylic acids, and dithiocarboxylic acids.

26. A composition as claimed in claim 22, wherein the first compound comprises an activated hydroxysilyl-functional group and the second compound comprises a sulfur-functionalized group.

27. A composition as claimed in claim 26, wherein the first compound comprises a hydroxysilylalkane derivative.

28. A composition as claimed in claim 26, further comprising an aprotic solvent.

29. A method of applying a monolayer on a substrate surface using the composition as claimed in claim 18.

30. A method as claimed in claim 29, wherein the first compound is selectively transferred to the first surface, while the second compound is substantially kept in the composition.

31. A method as claimed in claim 30, wherein the monolayer is applied according to a predefined pattern with soft-lithography.

32. A method as claimed in claim 31, wherein use is made of a stamp that is provided with a standardized pattern.

33. A method as claimed in claim 29, wherein the first compound is selectively transferred to the first surface on the substrate and the second compound is selectively transferred to the second surface on the substrate.

34. A method as claimed in claim 33, wherein the first and second compounds are applied to achieve homogenization of the surfaces on the substrate.

35. A method as claimed in claim 29, wherein the monolayer is applied on the substrate surface with soft-lithography and thereto wave printing is used.
